(19) United States
(12) Patent Application Publication
(10) Pub. No.: US 2026/0063604 A1
(43) Pub. Date: Mar. 5, 2026

(54) METHOD FOR SEARCHING GRADIENT CONDITION, NON- TRANSITORY COMPUTER-READABLE RECORDING MEDIUM, INFORMATION PROCESSING APPARATUS, AND ANALYSIS SYSTEM

(71) Applicant: SHIMADZU CORPORATION, Kyoto-shi (JP)

(72) Inventor: Tomohiro KAWASE, Kyoto-shi (JP)

(21) Appl. No.: 19/315,748

(22) Filed: Sep. 1, 2025

(30) Foreign Application Priority Data
Sep. 2, 2024 (JP) 2024-150665

(51) Int. Cl. G01N 30/86; G01N 30/02; G01N 30/34

(52) U.S. Cl. CPC G01N 30/8696; G01N 30/34; G01N 30/8658; G01N 2030/027

(57) ABSTRACT

A method for searching a gradient condition according to the present disclosure includes a step of receiving information specifying a target component, a step of acquiring first and second chromatogram data obtained by analyzing a sample containing two or more components under mutually different first and second gradient conditions, a step of creating, based on the first and second chromatogram data, a model for the target component that indicates a relationship between a gradient condition and a resolution, a step of using the model to calculate a predicted resolution of the target component corresponding to each of a plurality of gradient conditions, and a step of selecting, from the plurality of gradient conditions, a gradient condition for which the predicted resolution is the largest or for which the predicted resolution is equal to or greater than a threshold value.

### TECHNICAL FIELD

The present disclosure relates to a method for searching a gradient condition, a non-transitory computer-readable recording medium, an information processing apparatus, and an analysis system, and more particularly, to determining a gradient condition for separating a specific component from other components.

### BACKGROUND ART

In the gradient elution method used in liquid chromatography, where components in a sample are eluted while continuously changing the composition of two or more mobile phases, it is desired to improve the resolution of peaks derived from multiple components appearing on a chromatogram by adjusting the gradient condition that defines the temporal change in the mixing ratio of the two or more mobile phases.

Japanese Patent No. 7173159 (Patent Literature 1) discloses a technique that uses a regression model describing the relationship between gradient conditions and resolution to calculate the resolution for each peak in a chromatogram and presents to the user a distribution with the smallest resolution as an indicator. The resolution is an index indicating how well two adjacent peaks are separated, and the larger its value, the better the two peaks are separated. Therefore, the smallest resolution in a chromatogram is a value based on the two most closely spaced peaks in that chromatogram. If the smallest resolution in a chromatogram is equal to or greater than a threshold value (generally, a value of 1.5 or more is considered to be complete separation), it can be said that all peaks in the chromatogram are separated.

### PRIOR ART DOCUMENTS

### Patent Literature

[Patent Literature 1] Japanese Patent No. 7173159

### SUMMARY OF THE INVENTION

### Problem to be Solved by the Invention

According to Patent Literature 1, a user can recognize a gradient condition that increases the value of the smallest resolution in a chromatogram. In the distribution presented in Patent Literature 1, if the smallest resolution is equal to or greater than a threshold (e.g., 1.5), it can be said that the components in the sample are separated. However, especially when the number of components in a sample is large, the number of peaks in the chromatogram increases, and there may be cases where the smallest resolution is smaller than the threshold under any gradient condition. In such cases, it is difficult to completely separate all peaks.

In the above case, a user may desire a gradient condition that can separate a specific peak derived from the user's desired component, even if not all peaks can be separated. Patent Literature 1 does not address such a user's desire.

The present disclosure has been made in view of such circumstances, and its object is to determine a gradient condition that allows for the separation of a specific component from other components in the analysis of a sample by liquid chromatography.

### Means for Solving the Problem

A method for searching a gradient condition according to a first aspect of the present disclosure includes: (a) a step of receiving from a user information specifying a target component; (b) a step of acquiring first and second chromatogram data obtained by analyzing a sample containing two or more components, including the target component, under mutually different first and second gradient conditions; (c) a step of creating, based on the first and second chromatogram data, a model for the target component that indicates the relationship between the gradient condition and the resolution; (d) a step of using the model to calculate a predicted resolution of the target component corresponding to each of a plurality of gradient conditions; and (e) a step of selecting, from the plurality of gradient conditions, a gradient condition for which the predicted resolution is the largest or for which the predicted resolution is equal to or greater than a threshold value.

An information processing apparatus according to a second aspect of the present disclosure comprises at least one or more processors and a memory accessible by the one or more processors, wherein the memory stores one or more instructions to be executed by the processors, and the processors, by executing the one or more instructions, receive from a user information specifying a target component, acquire first and second chromatogram data obtained by analyzing a sample containing two or more components, including the target component, under mutually different first and second gradient conditions, create, based on the first and second chromatogram data, a model for the target component that indicates the relationship between the gradient condition and the resolution, use the model to calculate a predicted resolution of the target component corresponding to each of a plurality of gradient conditions, and select, from the plurality of gradient conditions, a gradient condition for which the predicted resolution is the highest or for which the predicted resolution is equal to or greater than a threshold value.

### Effects of the Invention

According to the present disclosure, in the analysis of a sample by liquid chromatography, it is possible to determine a gradient condition that allows for the separation of a specific component from other components.

### BRIEF DESCRIPTION OF THE DRAWINGS

FIG. 1 is a schematic diagram showing the configuration of an analysis system according to an embodiment.

FIG. 2 is a diagram showing an example of a chromatogram.

FIG. 3 is a diagram for explaining the processing related to the determination of a gradient condition.

FIG. 4 is a flowchart showing the processing for searching for a gradient condition.

### DESCRIPTION OF EMBODIMENTS

Hereinafter, embodiments of the present disclosure will be described in detail with reference to the drawings. In the drawings, the same or corresponding parts are denoted by the same reference numerals, and a description thereof will not be repeated.

### [Configuration of Analysis System]

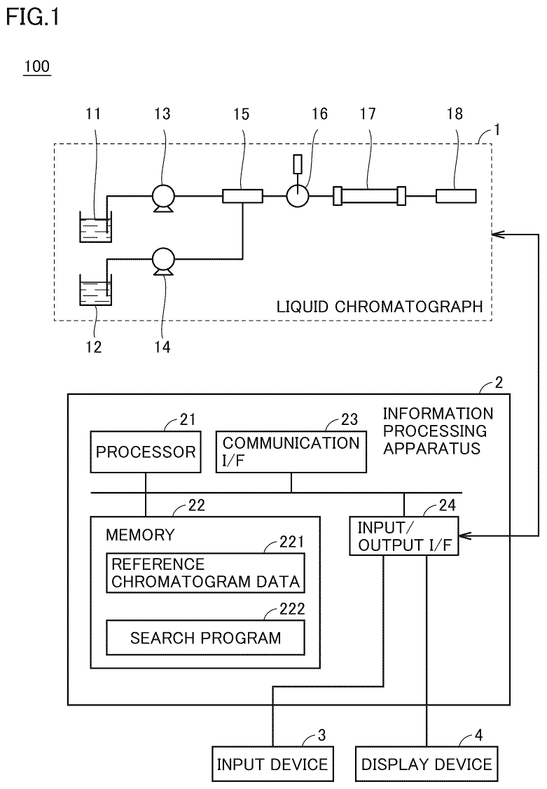

FIG. 1 is a diagram showing the configuration of an analysis system 100 according to an embodiment. Referring to FIG. 1, the analysis system 100 includes a liquid chromatograph 1, an information processing apparatus 2, an input device 3, and a display device 4. The analysis system 100 measures each of the components contained in an introduced sample.

The liquid chromatograph 1 includes a first container 11, a second container 12, a first pump 13, a second pump 14, a mixer 15, an injector 16, a column 17, and a detector 18. The liquid chromatograph 1 has a configuration for supplying a mobile phase according to the gradient elution method. The liquid chromatograph 1 separates and detects the components contained in a sample over time.

In the liquid chromatograph 1, a first solvent and a second solvent are prepared as solvents constituting the mobile phase. The first container 11 contains the first solvent, and the second container 12 contains the second solvent.

The first solvent and the second solvent have different elution strengths from each other. In one implementation, the first solvent is water, and the second solvent is methanol. The first solvent and the second solvent may contain an acidic solution (e.g., trifluoroacetic acid, formic acid, and ammonium formate) as an additive.

The first pump 13 draws the first solvent contained in the first container 11 and delivers it to an analysis flow path at a predetermined flow rate. The second pump 14 draws the second solvent contained in the second container 12 and delivers it to the analysis flow path at a predetermined flow rate.

The mixer 15 mixes the first solvent supplied from the first pump 13 and the second solvent supplied from the second pump 14. The information processing apparatus 2 controls the respective flow rates of the first pump 13 and the second pump 14 to adjust the respective flow rates of the first solvent and the second solvent in the mobile phase, thereby adjusting the ratio of the first solvent and the second solvent in the mobile phase.

The injector 16 injects a predetermined amount of a pre-prepared sample into the liquid chromatograph 1 into the mobile phase flow path. The sample is introduced from the injector 16 into the mobile phase delivered from the first pump 13 and the second pump 14, and the mobile phase containing the sample is introduced into the column 17.

The column 17 is packed with a stationary phase, and the mobile phase passes through its interior. As the sample passes through the column 17, the various components in the sample interact with the mobile phase and the stationary phase, whereby they are separated in the time direction. The column 17 may be housed in a column oven (not shown) and its temperature may be maintained at a predetermined temperature.

The detector 18 is a device for detecting each of the components separated in the column 17. The detector 18 acquires a detection signal based on each of the components separated in the column 17 and transmits the detection signal to the information processing apparatus 2. The detector 18 is, for example, an absorbance detector such as an ultraviolet absorbance detector (UV detector) or a photodiode array detector (PDA detector), a fluorescence detector, a differential refractive index detector, an evaporative light scattering detector, an electrochemical detector, and an electrical conductivity detector. The detector 18 may also be a mass spectrometer, in which case, the mass spectrometer analyzes the eluate introduced from the liquid chromatograph 1 and continuously acquires mass spectra. A mass spectrum is represented by a graph with the mass-to-charge ratio (m/z) of ions on the horizontal axis and the relative abundance of ions on the vertical axis. From the obtained mass spectra, the molecular weight, mass-to-charge ratio, and base peak mass of each component can be determined.

Although the liquid chromatograph 1 according to the present embodiment uses two types of solvents, a first solvent and a second solvent, to form the mobile phase, the number of solvents is not limited to this, and three or more types of solvents may be mixed to form the mobile phase. In this case, the liquid chromatograph 1 includes pumps for supplying each solvent to the mixer 15.

The information processing apparatus 2 controls the operations of the first pump 13, the second pump 14, and the injector 16, and also creates various calculations and chromatogram data based on the detection signal obtained by the detector 18, and searches for gradient conditions.

The information processing apparatus 2 includes, as main components, a processor 21, a memory 22, a communication interface (I/F) 23, and an input/output I/F 24. These components are communicably connected to each other via a bus. The information processing apparatus 2 is, for example, a computer. The information processing apparatus 2 does not need to be configured by a single computer and may be configured by a plurality of computers.

The processor 21 is an example of an electric circuit and controls the operation of the information processing apparatus 2 by executing a given program. The program executed by the processor 21 may be stored in the memory 22 or in a storage device external to the information processing apparatus 2. The processor is, for example, a CPU (Central Processing Unit).

The memory 22 non-transiently stores a program executed by the processor 21 and a chromatogram created based on the detection signal obtained by the detector 18. The program and chromatogram stored in the memory 22 include reference chromatogram data 221 and a search program 222. The memory 22 includes a volatile memory (e.g., RAM (Random Access Memory)) and a non-volatile memory (e.g., ROM (Read Only Memory), a hard disk drive, and a solid-state drive). The program and/or chromatogram may be stored in an external storage device accessible by the processor 21.

The reference chromatogram data 221 includes two or more chromatogram data obtained by analyzing the sample for which the gradient condition is to be searched under various gradient conditions.

The search program 222 uses the reference chromatogram data 221 to select a gradient condition that satisfies a predetermined condition. The details of the processing by the search program 222 will be described later.

The communication I/F 23 is a communication interface for exchanging various data with external devices. The communication I/F 23 is realized by, for example, a network adapter. The communication method may be wireless communication such as Bluetooth (registered trademark) or wireless LAN, or wired communication using USB (Universal Serial Bus) or the like.

The input/output I/F 24 is an interface for exchanging various data between the processor 21 and external devices connected to the input/output I/F 24. The external devices include the liquid chromatograph 1, the input device 3, and the display device 4.

In the analysis system 100 according to the present embodiment, the information processing apparatus 2 controls the liquid chromatograph 1, but another control device (e.g., a computer) may be connected to the liquid chromatograph 1, and the liquid chromatograph 1 may be controlled by the control device.

The input device 3 includes, for example, at least one of a mouse, a keyboard, and a touch panel, and receives operations for the information processing apparatus 2 and input of information to the information processing apparatus 2. The information is, for example, information specifying a peak derived from a target component that the user wishes to separate in a chromatogram. The information specifying the peak derived from the target component is, for example, information on the area of the peak derived from the target component, information on the height of the peak derived from the target component, and the elution order. The information on the area of the peak derived from the target component is, for example, the rank of the size of the peak derived from the target component among the peaks included in the chromatogram. The information on the height of the peak derived from the target component is, for example, the rank of the height of the peak derived from the target component among the peaks included in the chromatogram. When the detector 18 is a PDA, the information may be the wavelength of the peak of the target component. Furthermore, when the detector 18 is a mass spectrometer, the information may be the molecular weight, mass-to-charge ratio, or base peak mass of the target component.

The display device 4 includes, for example, a liquid crystal display, an organic EL (Electro Luminescence) display, or the like, and displays information according to instructions from the information processing apparatus 2. The information is, for example, the gradient condition for the sample for separating the target component output by the information processing apparatus 2, and a chromatogram estimated to be obtained when the sample is analyzed under the gradient condition.

### Comparative Example

In analysis using a liquid chromatograph, even when the same sample is analyzed, the resulting chromatogram varies depending on the analysis conditions such as the type of solvent used, the type of column, and the temperature during measurement. The gradient condition is also one of the analysis conditions that affect the chromatogram. The gradient condition defines the temporal change in the mixing ratio of two or more mobile phases. It is preferable to adjust the gradient condition to improve the resolution of peaks derived from multiple components appearing on the chromatogram.

The resolution is an index indicating how well a certain peak is separated from an adjacent peak. The resolution R is represented by the following formula (1), where T1 and T2 are the retention times of two adjacent peaks, and W1 and W2 are the peak widths of the two peaks, respectively.

$$\begin{matrix}[ Formula 1 ] & \\ R = \frac{T 1 - T 2}{\frac{1}{2} ( W 1 + W 2 )} & ( 1 )\end{matrix}$$

The larger the resolution of two peaks, the better the two peaks are separated. In one example, when the value calculated as the resolution with an adjacent peak for a certain peak is 1.5 or more, it is determined that the peak is completely separated. However, the resolution value (1.5) used here is merely an example and may be changed as appropriate according to the situation to which the technology according to the present disclosure is applied. In this specification, the resolution of a predetermined component refers to the smaller of the two resolution values calculated between the predetermined component and the two components eluted before and after it.

Patent Literature 1 discloses a technique that uses a regression model describing the relationship between gradient conditions and resolution to calculate the resolution for each peak in a chromatogram and presents to the user a distribution with the smallest resolution among the peaks in the chromatogram as an indicator.

According to Patent Literature 1, a user can recognize a gradient condition that increases the smallest resolution among the peaks included in a chromatogram. However, for example, when there are many components in a sample, it may not be possible to find a gradient condition such that the smallest resolution is equal to or greater than a threshold (e.g., 1.5). In such cases, it is difficult to completely separate all peaks. In such a case, a user may desire a gradient condition that can separate a specific peak, even if not all peaks can be separated.

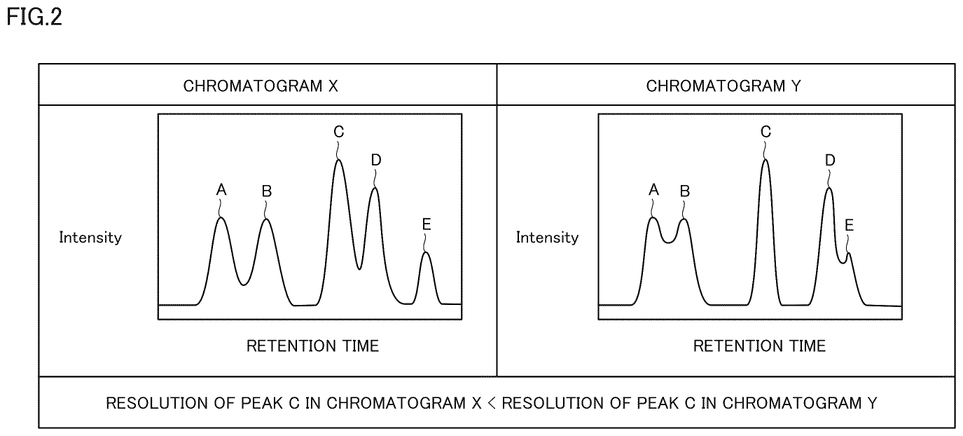

FIG. 2 shows an example of a chromatogram obtained by analyzing a sample containing five components, a to e, with a liquid chromatograph. FIG. 2 shows chromatograms obtained by analyzing the sample under two gradient conditions, gradient condition x and gradient condition y. The peaks derived from components a to e are referred to as peaks A to E, respectively.

The smallest resolution among the peaks included in chromatogram X obtained by gradient condition x is larger compared to other gradient conditions, but it is not equal to or greater than the threshold. Therefore, it is difficult to separate the five components a to e contained in the sample.

Here, when measuring component c in the sample, the user may wish to search for a gradient condition that can separate peak C derived from component c, even if not all components in the sample can be separated. In such a case, for example, a gradient condition y that increases the resolution of component c, as shown in FIG. 2, is sought. Since the resolution of peak C in chromatogram Y obtained by gradient condition y is larger than the resolution of peak C in chromatogram X, it can be said that gradient condition y is a more suitable gradient condition for separating component c than gradient condition x.

Patent Literature 1 does not consider comparing a plurality of gradient conditions using the resolution of a specific peak derived from a target component as an indicator.

### [Analysis System According to the Embodiment]

Therefore, in the analysis system according to the embodiment, a model indicating the relationship between the gradient condition and the resolution is created for a target component using chromatogram data obtained by analyzing a sample under various gradient conditions, and a gradient condition that can separate the peak derived from the target component from other peaks is searched for.

According to the analysis system of the present embodiment, it is possible to determine a gradient condition that can separate a peak derived from a target component from other peaks, and by analyzing a sample under the gradient condition, the target component can be measured.

In this specification, the resolution of a predetermined peak refers to the smaller of the two resolution values calculated between the predetermined peak and each of the peaks before and after the predetermined peak. When a predetermined component corresponds to the peak with the earliest elution order or the latest elution order in a chromatogram, the resolution of the predetermined component refers to the resolution with the peak adjacent to the peak corresponding to the predetermined component.

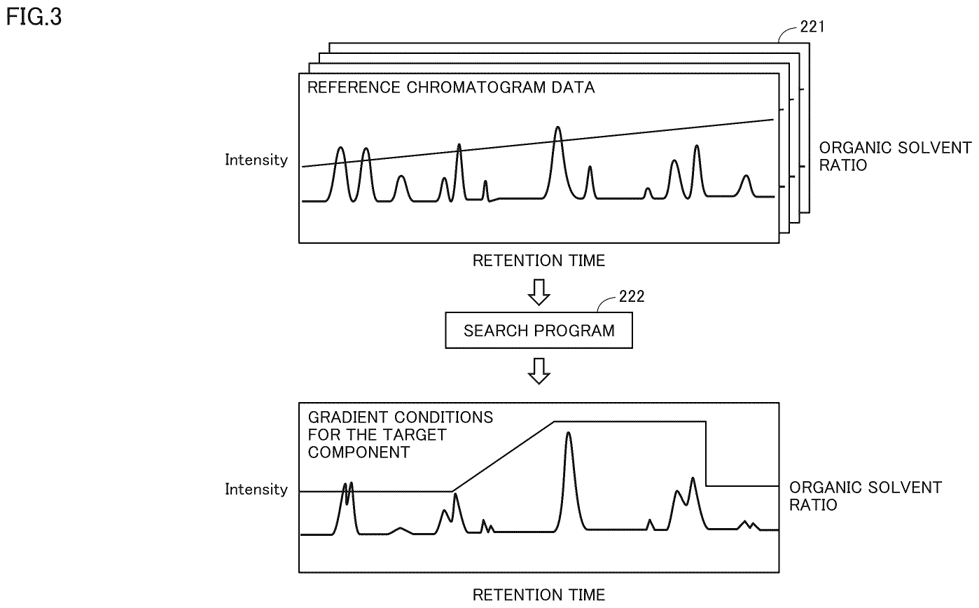

Hereinafter, the process by which the analysis system 100 selects a gradient condition will be described. FIG. 3 is a block diagram for explaining the procedure by which the analysis system 100 searches for a gradient condition.

As shown in FIG. 3, the information processing apparatus 2 executes the search program 222. First, the information processing apparatus 2 calls the reference chromatogram data 221 from the memory 22. The reference chromatogram data 221 includes chromatogram data obtained by analyzing the sample for which the analysis system 100 determines the gradient condition under two or more different gradient conditions.

The information processing apparatus 2 receives information specifying a target component from a user via the input device 3. The target component is not limited to a single compound and may include a plurality of compounds. The information processing apparatus 2 may also read the information specifying the target component from the memory 22.

The target component is a component that the user wishes to separate from other components among the components contained in the sample. The information for specifying the target component is information necessary for specifying the peak derived from the target component in the reference chromatogram data 221, and is, for example, information on the area of the peak corresponding to the target component, information on the height of the peak corresponding to the target component, and the elution order of the target component. The information on the area of the peak corresponding to the target component is, for example, the rank of the size of the peak derived from the target component among the peaks included in the chromatogram. The information on the height of the peak corresponding to the target component is, for example, the rank of the height of the peak derived from the target component among the peaks included in the chromatogram. When the detector 18 is a PDA, the information may be the wavelength of the peak of the target component. Furthermore, when the detector 18 is a mass spectrometer, the information may be the molecular weight of the target component, the mass-to-charge ratio of the target component, or the base peak mass of the target component.

Subsequently, the information processing apparatus 2 identifies the peaks included in one of the chromatogram data in the reference chromatogram data 221. The peaks are detected by, for example, peak waveform processing. The detected peaks are associated with corresponding peaks in other reference chromatogram data 221. Specifically, for example, based on at least one of the elution order, peak waveform, peak area, peak height, spectrum information when the detector 18 is a PDA, and mass spectrum information when the detector 18 is a mass spectrometer, each of the peaks detected in each of the two or more chromatogram data included in the reference chromatogram data 221 is associated.

Each peak included in the reference chromatogram data 221 is derived from each component included in the sample. Therefore, by the above process, the peak of each component included in the sample under each gradient condition is identified. This makes it possible to identify the peak of the target component in the reference chromatogram data 221.

The information processing apparatus 2 extracts the retention time and peak width for each component under each gradient condition from the reference chromatogram data 221.

Next, the information processing apparatus 2 creates a model indicating the relationship between the gradient condition and the resolution for the target component. Specifically, based on the retention times and peak widths of the target component and the components eluted before and after the target component under each gradient condition, a model is created for predicting the retention times and peak widths of the target component and the components eluted before and after the target component under a plurality of unmeasured gradient conditions, and from these, calculating a predicted resolution, which is a predicted value of the resolution of the target component, under the plurality of unmeasured gradient conditions.

An example of a method related to model creation is shown below. In one embodiment, the model for calculating the predicted resolution of the target component is created using the measured values of the retention times and peak widths of the target component and the components eluted before and after the target component in the chromatogram data of the reference chromatogram data 221. For the predicted values of the retention time and peak width of each component, a model equation showing the relationship between the gradient condition and the retention time, and a model equation showing the relationship between the gradient condition and the peak width are used. That is, creating the model includes calculating, for each of the target component and the components eluted before and after the target component, the coefficients in those model equations from the measured values of the elution times and peak widths of each peak in the reference chromatogram data 221, and the model includes the model equations.

First, the model equation for predicting the retention time will be described. The migration speed of a compound can be expressed by the reciprocal of the retention factor, and the relationship between the retention time tR and the retention factor at each time k(t) is expressed by the following formula (2), where the dwell time is tD and the dead time is t0.

$$\begin{matrix}[ Formula 2 ] & \\ {t}_{0} = \frac{{t}_{D}}{k ( 0 )} + {\int }_{0}^{{t}_{R} - {t}_{0} - {t}_{D}} \frac{1}{k ( t )} dt & ( 2 )\end{matrix}$$

tD is calculated as system volume/flow rate, and t0 is calculated as column volume/flow rate. Also, k(0) indicates the retention factor in the mobile phase composition before time 0. It is assumed that the mobile phase composition is fixed and the retention factor does not change until the analysis starts.

Also, the relationship between the organic solvent concentration and the retention factor during reversed-phase analysis is expressed by the following formula (3), where φ(t) is the organic solvent ratio of the mobile phase at each time, and k0 is the retention factor when the organic solvent ratio is 0.

$$\begin{matrix}[ Formula 3 ] & \\ ln k ( t ) = ln {k}_{0} - {S}_{1} φ ( t ) + {S}_{2} {\{ φ ( t ) \}}^{2} & ( 3 )\end{matrix}$$

In formula (3), S1 and S2 are coefficients, and these vary depending on the type of sample, mobile phase, and column.

The information processing apparatus 2 determines k0, S1, and S2 by fitting the retention time of the peak and the temporal change of the organic solvent ratio in the acquired reference chromatogram data 221, and creates a model equation related to the retention time for each component. By substituting an arbitrary gradient condition into the created model equation, a predicted value of the retention time of each component under that gradient condition can be obtained.

Next, the model equation for predicting the peak width will be described.

It is known that during reversed-phase gradient analysis, the peak width tends to change with respect to the magnitude of the retention time, which is called peak compression. Peak compression is expressed by the following formula (4), where G is the compression factor, W is the peak width, k(tR) is the retention factor at elution, and N is the number of theoretical plates of the column.

$$\begin{matrix}[ Formula 4 ] & \\ W = 4 {Gt}_{0} ( 1 + k ( {t}_{B} ) ) / \sqrt{N} & ( 4 )\end{matrix}$$

The retention factor k(tR) can be calculated based on formula (3).

The compression factor G is expressed by the following formula (5) using the retention factor.

$$\begin{matrix}[ Formula 5 ] & \\ {G}^{2} = \frac{{k ( {t}_{R} )}^{2}}{{{t}_{0} ( 1 + k ( {t}_{R} ) )}^{2}} \{ \frac{{t}_{D} ( 1 + {k ( 0 )}^{3} )}{{k ( 0 )}^{3}} + {\int }_{1}^{{t}_{R} - {t}_{0} - {t}_{D}} \frac{{( 1 + k ( t ) )}^{2}}{{k ( t )}^{3}} dt \} & ( 5 )\end{matrix}$$

Similar to the creation of the model equation for retention time, the information processing apparatus 2 determines each coefficient by fitting based on the acquired reference chromatogram data 221 and creates a model equation related to the peak width for each component. By substituting an arbitrary gradient condition into the created model equation, a predicted value of the peak width of the peak under that gradient condition can be obtained.

The model equations used for creating the model are not limited to the mathematical formulas described above. The model equations for estimating the retention time and peak width may be exponential functions, polynomials, or kernel regression such as Gaussian kernel regression. Further, the model equations for estimating the retention time and peak width may be functions of the same shape or functions of different shapes from each other.

In the embodiment described above, model equations were used to predict the retention time and peak width, but the present invention is not limited to this, and for example, the retention time and peak width may be predicted by machine learning.

Under a predetermined gradient condition, the predicted resolution of the target component under the predetermined gradient condition can be obtained using the predicted values of the retention times and peak widths of the target component and the components eluted before and after it.

In the embodiment described above, in order to calculate the predicted resolution of the target component, the predicted values of the retention times and peak widths of the components eluted before and after the target component in one chromatogram data of the reference chromatogram data 221 were used. However, the components eluted before and after the target component in the one chromatogram data are not necessarily eluted before and after the target component in different chromatogram data. Therefore, the predicted resolution of the target component may be obtained by predicting the retention times and peak widths for all components contained in the sample, or the predicted values of the retention times and peak widths of the components eluted within the fifth position before and after the target component in one chromatogram data of the reference chromatogram data 221 may be used. The smaller the number of predicted values of retention time and peak width used to calculate the predicted resolution of the target component, the lighter the load on the information processing apparatus 2 for model creation.

The information processing apparatus 2 calculates the predicted resolution of the target component in each of a plurality of gradient conditions with different gradient conditions, using the created model. The plurality of gradient conditions may be specified by the user or may be predetermined. The plurality of gradient conditions are, for example, gradient conditions in which the initial organic solvent concentration is shifted by 5% at a time, such as 0%, 5%, 10% . . . , in the gradient condition under which one chromatogram data of the reference chromatogram data 221 was acquired.

The information processing apparatus 2 selects, from the plurality of gradient conditions, a gradient condition for which the predicted resolution of the target component is the largest, or a gradient condition for which the predicted resolution of the target component is equal to or greater than a threshold value. The threshold value is, for example, 1.5.

The information processing apparatus 2 may search for a gradient condition for which the predicted resolution of the target component is larger than the plurality of gradient conditions for which the predicted resolution of the target component was calculated. The information processing apparatus 2 searches for a gradient condition for which the predicted resolution of the target component is the largest, for example, by Bayesian optimization.

The information processing apparatus 2 may also select a gradient condition based on an evaluation value obtained by applying the derived predicted resolution to a function having the resolution value of the target component as a variable. In particular, when the target component includes a plurality of compounds, by applying the predicted resolution calculated for each compound to the function and selecting a gradient condition based on the obtained evaluation value, it is possible to search for a gradient condition that can separate the plurality of compounds. Specifically, for example, the larger the evaluation value derived from the function, the more preferable the corresponding gradient condition is. The function may also have the value of the minimum resolution in the corresponding gradient condition as a variable. The information processing apparatus 2 derives evaluation values for a plurality of gradient conditions and searches for a gradient condition that maximizes the evaluation value by Bayesian optimization. The information processing apparatus 2 selects the gradient condition that maximizes the evaluation value as the gradient condition for separating the target component.

The function having the resolution value of the target component as a variable may further have at least one of the final peak elution time, the initial organic solvent concentration of the mobile phase, the final organic solvent concentration of the mobile phase, and a confidence level as a variable. The confidence level indicates the robustness of the predicted resolution calculated by the model and includes, for example, information on whether the gradient condition is a linear gradient or a step gradient. In general, a linear gradient has higher robustness of the predicted resolution of the target component than a step gradient, so the confidence level becomes higher. The confidence level may also be given a different score depending on the number of steps in a step gradient. In general, the smaller the number of steps in a step gradient, the higher the robustness of the predicted resolution of the target component, so the confidence level becomes higher.

After selecting the gradient condition for separating the target component, the information processing apparatus 2 displays the gradient condition and a chromatogram estimated to be obtained when the sample is analyzed under the gradient condition on the display device 4.

By analyzing the sample under the gradient condition displayed on the display device 4, the user can separate the target component from other components by liquid chromatography and measure the target component.

The chromatogram data obtained by measuring the sample under the selected gradient condition may be added to the reference chromatogram data 221, and the search for a gradient condition may be performed again. This process can improve the prediction accuracy of the model.

### [Flowchart]

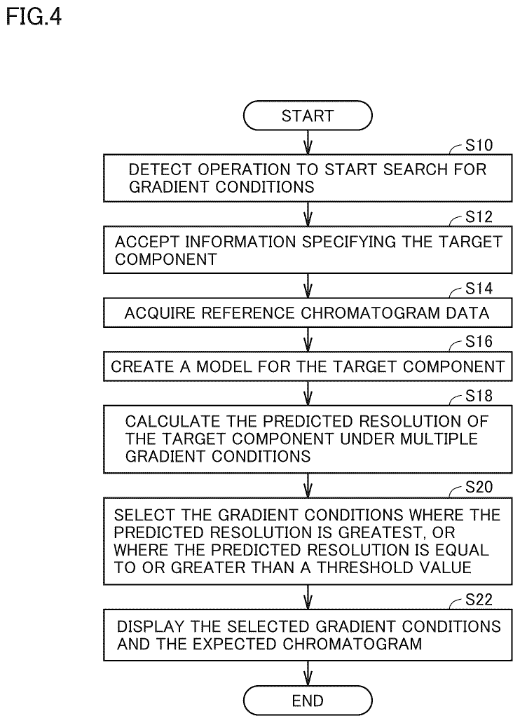

FIG. 4 is a flowchart for explaining the processing related to the search for a gradient condition. The information processing apparatus 2 causes the processor 21 to execute the search program 222 to implement the processing of this flowchart.

Referring to FIG. 4, in step S10, the processor 21 detects an operation to start the search for a gradient condition. For example, when the user performs an operation to start the search for a gradient condition using the input device 3, that operation is detected in step S10.

In step S12, the processor 21 receives from the user information specifying a target component. The information specifying the target component includes at least one of, for example, information on the area of the peak derived from the target component, information on the height of the peak derived from the target component, the PDA wavelength of the target component, the molecular weight of the target component, the mass-to-charge ratio of the target component, and the base peak mass of the target component. The target component is not limited to one compound and may include a plurality of compounds.

In step S14, the processor 21 reads out and acquires the reference chromatogram data 221 from the memory 22. The reference chromatogram data 221 includes a plurality of chromatogram data obtained by analyzing a sample containing two or more components under one or more different gradient conditions.

In step S16, the processor 21 creates a model indicating the relationship between the gradient condition and the resolution for the target component based on the reference chromatogram data 221.

In step S18, the processor 21 uses the model created in step S16 to calculate a predicted resolution, which is a predicted value of the resolution of the target component corresponding to each of a plurality of different gradient conditions.

In step S20, the processor 21 selects, from the predicted resolutions calculated in step S18, a gradient condition for which the predicted resolution is the largest, or a gradient condition for which the predicted resolution is equal to or greater than a threshold value. The threshold value may be specified by the user or may be predetermined, and is, for example, 1.5.

In step S22, the processor 21 causes the display device 4 to display the selected gradient condition and a chromatogram obtained by measuring the sample under the gradient condition. Thereafter, the processor 21 ends the series of processes shown in FIG. 4.

According to the method for searching a gradient condition of the present embodiment, in the measurement of a sample by a liquid chromatograph using two or more solvents as a mobile phase, it is possible to search for a gradient condition that can separate a specific component contained in the sample from other components.

### Aspects

Those skilled in the art will understand that the plurality of exemplary embodiments described above are specific examples of the following aspects.

(Aspect 1) A method for searching a gradient condition may include: a step of receiving information specifying a target component; a step of acquiring first and second chromatogram data obtained by analyzing a sample containing two or more components under mutually different first and second gradient conditions; a step of creating, based on the first and second chromatogram data, a model for the target component that indicates a relationship between a gradient condition and a resolution; a step of using the model to calculate a predicted resolution of the target component corresponding to each of a plurality of gradient conditions; and a step of selecting, from the plurality of gradient conditions, a gradient condition for which the predicted resolution is the largest or for which the predicted resolution is equal to or greater than a threshold value.

According to the method for searching a gradient condition described in Aspect 1, in the analysis of a sample by liquid chromatography, it is possible to determine a gradient condition that allows for the separation of a specific component from other components.

(Aspect 2) In the method for searching a gradient condition described in Aspect 1, the step of creating the model may have a step of calculating, for the target component, a coefficient in a first model equation indicating a relationship between a gradient condition and a retention time, and a step of calculating, for the target component, a coefficient in a second model equation indicating a relationship between a gradient condition and a peak width, and the model may include the first and second model equations.

According to the method for searching a gradient condition described in Aspect 2, a model indicating the relationship between the gradient condition and the resolution of the target component is created using model equations indicating the respective relationships between the gradient condition and the retention time and peak width.

(Aspect 3) In the method for searching a gradient condition described in Aspect 1 or 2, the selecting step may have a step of calculating an evaluation value by applying the predicted resolution to a function having a value of the resolution of the target component as a variable.

According to the method for searching a gradient condition described in Aspect 3, a gradient condition is searched based on an evaluation value obtained by applying the predicted resolution to a function having the value of the resolution of the target component as a variable.

(Aspect 4) In the method for searching a gradient condition described in Aspect 3, the function may further have at least one of a final peak elution time, an initial organic solvent concentration of a mobile phase, a final organic solvent concentration of the mobile phase, and a confidence level as a variable.

According to the method for searching a gradient condition described in Aspect 4, it is possible to search for a gradient condition using a function that reflects at least one value among the final peak elution time, the initial organic solvent concentration of the mobile phase, the final organic solvent concentration of the mobile phase, and the confidence level.

(Aspect 5) In the method for searching a gradient condition described in Aspect 4, the confidence level may include the number of steps allowed in a step gradient.

According to the method for searching a gradient condition described in Aspect 5, the function used for searching for the gradient condition is based on a confidence level, and the confidence level includes information regarding the number of steps allowed in a step gradient. Specifically, a gradient condition that does not include a step gradient is treated as a more preferable condition than a gradient condition that includes a step gradient.

(Aspect 6) In the method for searching a gradient condition described in any one of Aspects 3 to 5, the selecting step may further have a step of searching, by Bayesian optimization, for a gradient condition for which the value of the evaluation value is the minimum from among the plurality of gradient conditions.

According to the method for searching a gradient condition described in Aspect 6, a gradient condition for which the evaluation value is the largest is searched for using Bayesian optimization. Using Bayesian optimization improves the efficiency of searching for a gradient condition.

(Aspect 7) In the method for searching a gradient condition described in any one of Aspects 1 to 6, the target component may include two or more compounds.

According to the method for searching a gradient condition described in Aspect 7, it is possible to search for a gradient condition for separating a target component that includes two or more compounds.

(Aspect 8) In the method for searching a gradient condition described in any one of Aspects 1 to 7, the information for specifying the target component may include at least one of information on an area of a peak derived from the target component, information on a height of a peak derived from the target component, a molecular weight of the target component, a mass-to-charge ratio of the target component, and a base peak mass of the target component.

According to the method for searching a gradient condition described in Aspect 8, the target component is specified based on at least one of information on the area of a peak, information on the height of a peak, the molecular weight of the target component, the mass-to-charge ratio, and the base peak mass.

(Aspect 9) The method for searching a gradient condition described in any one of Aspects 1 to 8 may further include a step of displaying a chromatogram estimated to be obtained by measuring the sample under the gradient condition selected in the selecting step.

According to the method for searching a gradient condition described in Aspect 9, a user can easily recognize a chromatogram estimated to be obtained by measuring the sample. Further, based on the chromatogram, the user can decide whether to measure the sample under the determined gradient condition or to continue searching for a gradient condition.

(Aspect 10) A program according to one aspect may, by being executed by a processor mounted on a computer, cause the computer to execute the method for searching a gradient condition described in any one of Aspects 1 to 9.

According to the program described in Aspect 10, in the analysis of a sample by liquid chromatography, it is possible to determine a gradient condition that allows for the separation of a specific component from other components.

(Aspect 11) An information processing apparatus according to one aspect may comprise at least one or more processors and a memory accessible by the one or more processors, wherein the memory stores one or more instructions to be executed by the processor, and the processor, by executing the one or more instructions, receives information specifying a target component, acquires first and second chromatogram data obtained by analyzing a sample containing two or more components under mutually different first and second gradient conditions, creates, based on the first and second chromatogram data, a model for the target component that indicates a relationship between a gradient condition and a resolution, uses the model to calculate a predicted resolution of the target component corresponding to each of a plurality of gradient conditions, and selects, from the plurality of gradient conditions, a gradient condition for which the predicted resolution is the largest or for which the predicted resolution is equal to or greater than a threshold value.

According to the information processing apparatus described in Aspect 11, in the analysis of a sample by liquid chromatography, it is possible to determine a gradient condition that allows for the separation of a specific component from other components.

(Aspect 12) An analysis system according to one aspect may comprise the information processing apparatus described in Aspect 11 and a liquid chromatograph.

According to the analysis system described in Aspect 12, in the analysis of a sample by liquid chromatography, it is possible to determine a gradient condition that allows for the separation of a specific component from other components.

The embodiments disclosed herein should be considered in all respects as illustrative and not restrictive. The scope of the present disclosure is indicated by the claims rather than by the foregoing description of the embodiments, and all changes which come within the meaning and range of equivalency of the claims are intended to be embraced therein. Further, it is intended that each technology in the embodiments may be implemented alone or, where necessary, in combination with other technologies in the embodiments as much as possible.

### DESCRIPTION OF REFERENCE NUMERALS

1 Liquid chromatograph, 2 Information processing apparatus, 3 Input device, 4 Display
device, 11 First container, 12 Second container, 13 First pump, 14 Second pump, 15 Mixer,
16 Injector, 17 Column, 18 Detector, 21 Processor, 22 Memory, 23 Communication I/F,
24 Input/output I/F, 100 Analysis system, 221 Reference chromatogram data, 222 Search
program.

1. A method for searching a gradient condition, comprising the steps of:
receiving information specifying a target component;
acquiring first and second chromatogram data obtained by analyzing a sample containing two or more components under mutually different first and second gradient conditions;
creating, based on the first and second chromatogram data, a model for the target component that indicates a relationship between a gradient condition and a resolution;
using the model to calculate a predicted resolution of the target component corresponding to each of a plurality of gradient conditions; and
selecting, from the plurality of gradient conditions, a gradient condition for which the predicted resolution is the largest or for which the predicted resolution is equal to or greater than a threshold value.

2. The method for searching a gradient condition according to claim 1,
wherein the step of creating the model has:
a step of calculating, for the target component, a coefficient in a first model equation indicating a relationship between a gradient condition and a retention time; and
a step of calculating, for the target component, a coefficient in a second model equation indicating a relationship between a gradient condition and a peak width, and
wherein the model includes the first and second model equations.

3. The method for searching a gradient condition according to claim 1, wherein the selecting step has a step of calculating an evaluation value by applying the predicted resolution to a function having a value of the resolution of the target component as a variable.

4. The method for searching a gradient condition according to claim 3, wherein the function further has at least one of a final peak elution time, an initial organic solvent concentration of a mobile phase, a final organic solvent concentration of the mobile phase, and a confidence level as a variable.

5. The method for searching a gradient condition according to claim 4, wherein the confidence level includes a number of steps allowed in a step gradient.

6. The method for searching a gradient condition according to claim 3, wherein the selecting step further has a step of searching, by Bayesian optimization, for a gradient condition for which a value of the evaluation value is the maximum from among the plurality of gradient conditions.

7. The method for searching a gradient condition according to claim 1, wherein the target component includes two or more compounds.

8. The method for searching a gradient condition according to claim 1, wherein the information specifying the target component includes at least one of information on an area of a peak derived from the target component, information on a height of a peak derived from the target component, a molecular weight of the target component, a mass-to-charge ratio of the target component, and a base peak mass of the target component.

9. The method for searching a gradient condition according to claim 1, further comprising a step of displaying a chromatogram estimated to be obtained by measuring the sample under the gradient condition selected in the selecting step.

10. A non-transitory computer-readable recording medium storing a program which, when executed by a processor mounted on a computer, causes the computer to execute the method for searching a gradient condition according to claim 1.

11. An information processing apparatus, comprising:
at least one or more processors; and
a memory accessible by the one or more processors,
wherein the memory stores one or more instructions to be executed by the processor, and
wherein the processor, by executing the one or more instructions:
receives information specifying a target component;
acquires first and second chromatogram data obtained by analyzing a sample containing two or more components under mutually different first and second gradient conditions;
creates, based on the first and second chromatogram data, a model for the target component that indicates a relationship between a gradient condition and a resolution;
uses the model to calculate a predicted resolution of the target component corresponding to each of a plurality of gradient conditions; and
selects, from the plurality of gradient conditions, a gradient condition for which the predicted resolution is the largest or for which the predicted resolution is equal to or greater than a threshold value.

12. An analysis system, comprising:
the information processing apparatus according to claim 11; and
a liquid chromatograph.
